(19) United States
(12) Patent Application Publication
(10) Pub. No.: US 2011/0122083 A1
(43) Pub. Date: May 26, 2011

(54) INFORMATION TERMINAL

(75) Inventors: Hiroyuki Takahashi, Tokyo (JP); Shugo Takahashi, Tokyo (JP); Taichi Kouno, Tokyo (JP)

(73) Assignee: CAMELOT CO., LTD., Tokyo (JP)

(21) Appl. No.: 13/003,924

(22) PCT Filed: Jul. 17, 2009
(86) PCT No.: PCT/JP2009/062993

§ 371 Date: Jan. 13, 2011

(30) Foreign Application Priority Data
Jul. 17, 2008 (JP) 2008-186496

(51) Int. Cl. G06F 3/041; G09G 5/00

(52) U.S. Cl. 345/173; 345/156

(57) ABSTRACT

In information terminals, such as the cellular phone, the user interface for being adapted to enough in multi-functionalization is provided. The portable communication terminal with the touch panel on the surface of body, a display information generating section which generates the display information displayed on the touch panel, a manipulation position detector which detects the coordinate point specified on the touch panel, wherein the display information generating section divides the touch panel into a plurality of display ranges, and changes the ratio of a plurality of display ranges depending on the relative position detected by the manipulation position detector.

### TECHNICAL FIELD

The present invention relates to an information terminal equipped with a display on the surface of the body like a cellular phone.

### BACKGROUND ART

In recent years, about information terminals, such as a cellular phone, while miniaturization of the body is required, with the advance of multi-functionalization, such as transmission/reception of e-mail, connection to the Internet, and camera photographing, regarding the cellular phone, adaptation to multimedia and the operativity of the user interface are required.

Now, usually, even though the cellular phones operated with a single hand are miniaturized in consideration of the portability and the operativity, because the key are operated with watching the display screen, the display screen of the cellular phone, and the various keys, such as the numeric keys and the selection operation keys, had to be positioned separately. For this reason, the display screen must be arranged into a part except for the various keys, and an expansion of the screen was not enough to enjoy multimedia comfortably with the cellular phone, because space for the display is limited to the half of the arrangement surface.

As opposed to this, an art disclosed by the patent literature 1 propose that a display screen which displays the variety of information placed in the different side from the an operation key side for inputting the various manipulate signals. According to the art shown by the patent literature 1, the display screen of sufficient size to display various information is gained, without consideration to the key arrangement.

[Patent Literature 1] Japanese Patent Application No. 2002-354085

### SUMMARY OF THE INVENTION

### Technical Problem

However, as mentioned above, although diversification of the user interface is also required more with rising of needs for multimedia, because the key arrangement required depending on the kind of multimedia differs, in the fixed interface, there is the problem that it cannot respond enough to needs.

The present invention has been made in order to solve the problems as described above, and it is an object to provide a system with the user interface which can respond to multi-functionalization enough in information terminals, such as the cellular phone.

### Solution to Problem

In order to accomplish the object as described above, the present invention provides an information terminal with a display on the surface of the body comprising: a display information generating section for generating the display information displayed on the display; and a position detector for detecting the coordinate point specified on the display; wherein the display information generating section divides the display into a plurality of the display ranges, and changes the ratio of the a plurality of the display ranges depending on the relative position detected by the position detector.

In accordance with the present invention as described above, since the screen was divided into a plurality of display ranges, the information displayed on the screen of the information terminal is made clear, and the display mode can be varied according to each function of the information terminal, and it is possible to respond to multi-functionalization of the information terminal.

In the invention as described above, it is preferred that a touch panel provided in the display for inputting the manipulate signal with the pressure to the display; and a input range setting section for dividing the input range for the manipulate signal on the touch panel; wherein the input range setting section changes the input range depending on the relative position detected by the position detector.

In this case, on the touch panel, a plurality of display ranges and input ranges can be placed, the coordinate point on the display is specified by touching and dragging the boundary line of the display range or the input range, by detecting this, the ratio of a plurality of display ranges or the input range can be changed, thereby, the area of each display range can be expanded and contracted.

In the invention as described above, it is preferred that The information terminal comprising a gadget section slid to the longitudinal direction in the surface of the body, wherein a position detector detects the coordinate point with the relative position of the gadget section in the body, and a display information generating section changes the display information depending on the relative position of the gadget section in the body detected by the position detector.

In this case, the coordinate point on the display is specified with the position of the gadget section, by moving the gadget section, the boundary line at the time of dividing into a plurality of display ranges can be changed freely, thereby, the area of each display range can be expanded and contracted.

In the invention as described above, it is preferred that the information terminal comprising a acceleration sensor for detecting the value and the direction of acceleration wherein the display information generating section changes the display information depending on the relative position detected by the position detector and the acceleration detected by the acceleration sensor, and the input range setting section changes the input range depending on the relative position detected by the position detector and the acceleration detected by the acceleration sensor. In this case, based on the boundary layer position of the display range divided into the plurality, and the acceleration given to the body, the display style can be changed and the interface can be varied.

In the invention as described above, it is preferred that the information terminal comprising a input part provided in the gadget section for inputting the manipulate signal. In this case, the manipulate signal can be inputted from the gadget section itself, and diversification of the interface can be attained further.

In the invention as described above, it is preferred that the display information generating section has the function for setting up the range which displays the display information on the display, and the input range setting section each locates the gadget section and the input range in the both sides of the display range of the display information by dividing the input range depending on the relative position detected by the position detector. In this case, because the input interface can be placed on those both sides as situated across the display range, the manual operation button and the arrow key can be placed on both sides of the game screen, for example as the game controller.

### Advantageous Effects of Invention

As has been discussed above, in accordance with the present invention, In information terminals, such as the cellular phone, the user interface, for telephone call manipulation, mail preparation, or contents viewing, enough according to multi-functionalization can be provided by setting up a plurality of display ranges and input ranges on the display, making these boundary lines change freely, and making each range expand and contract.

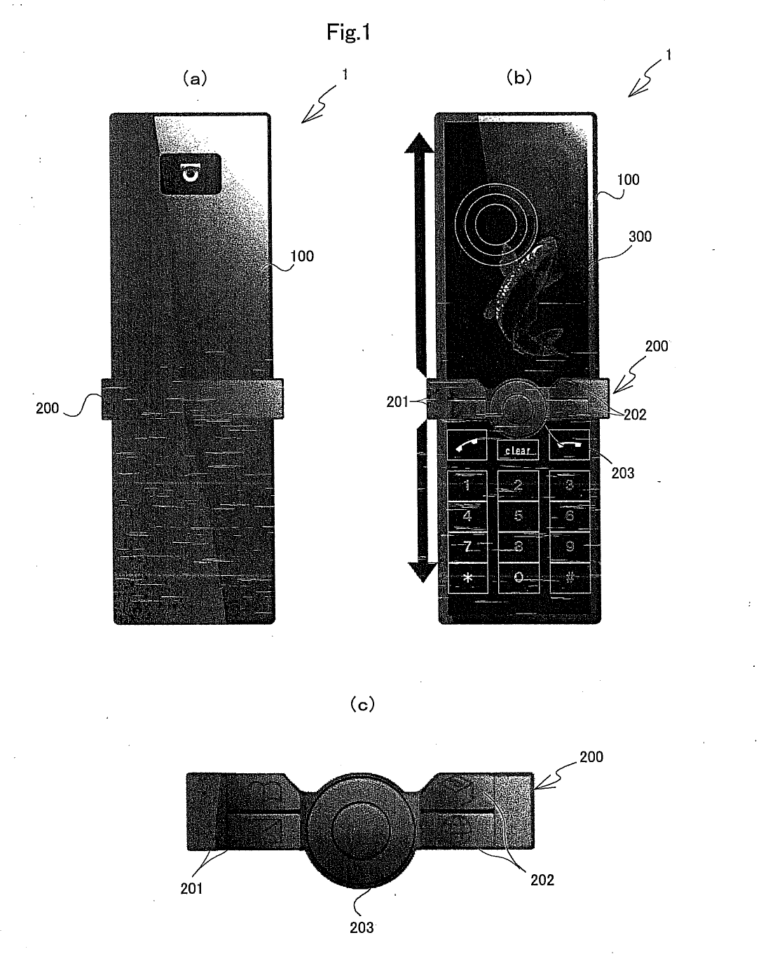

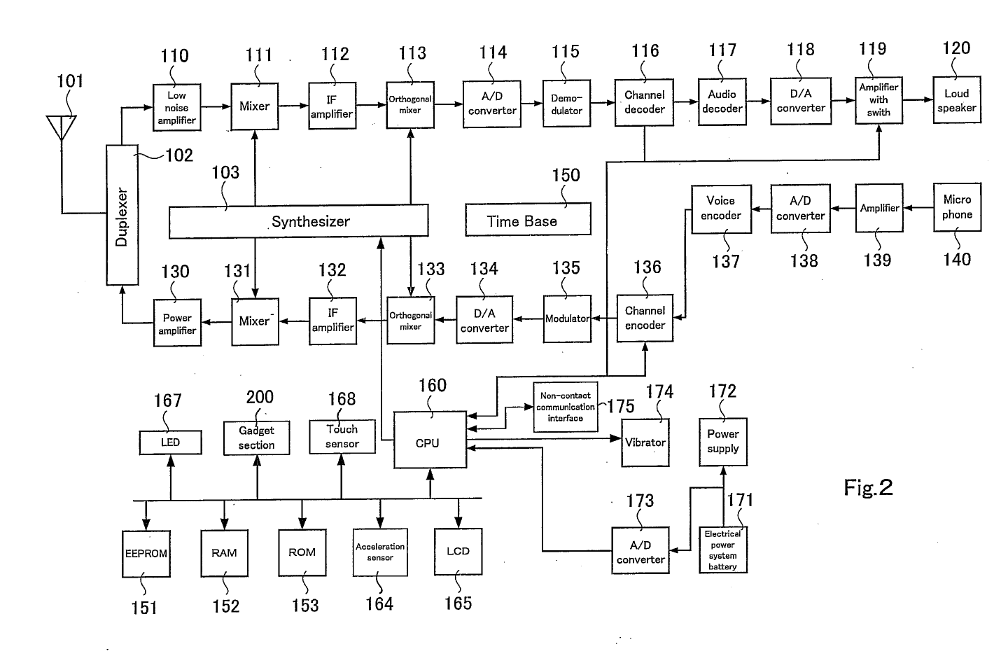

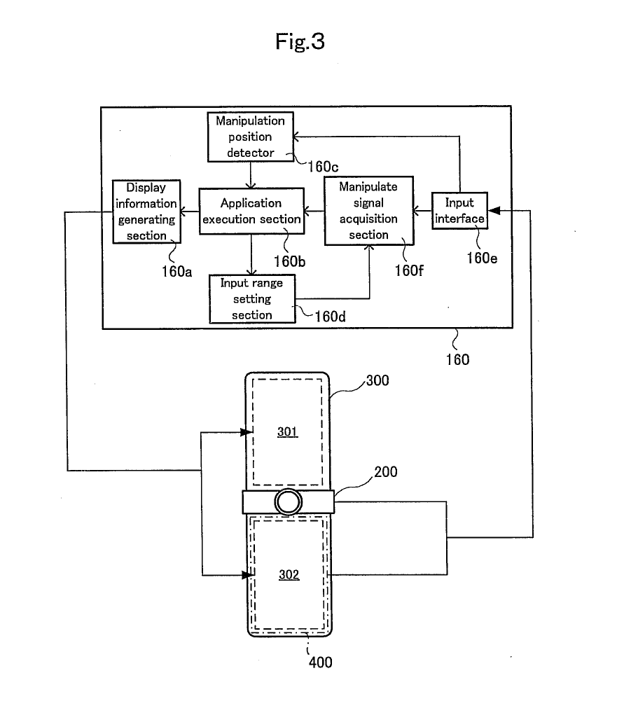

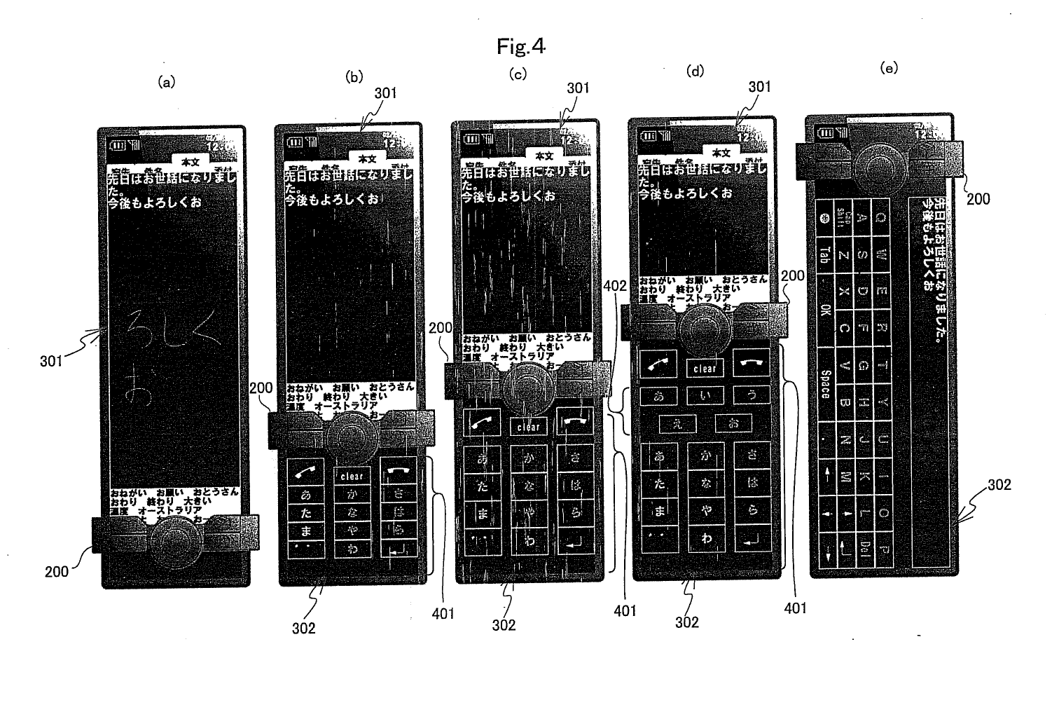

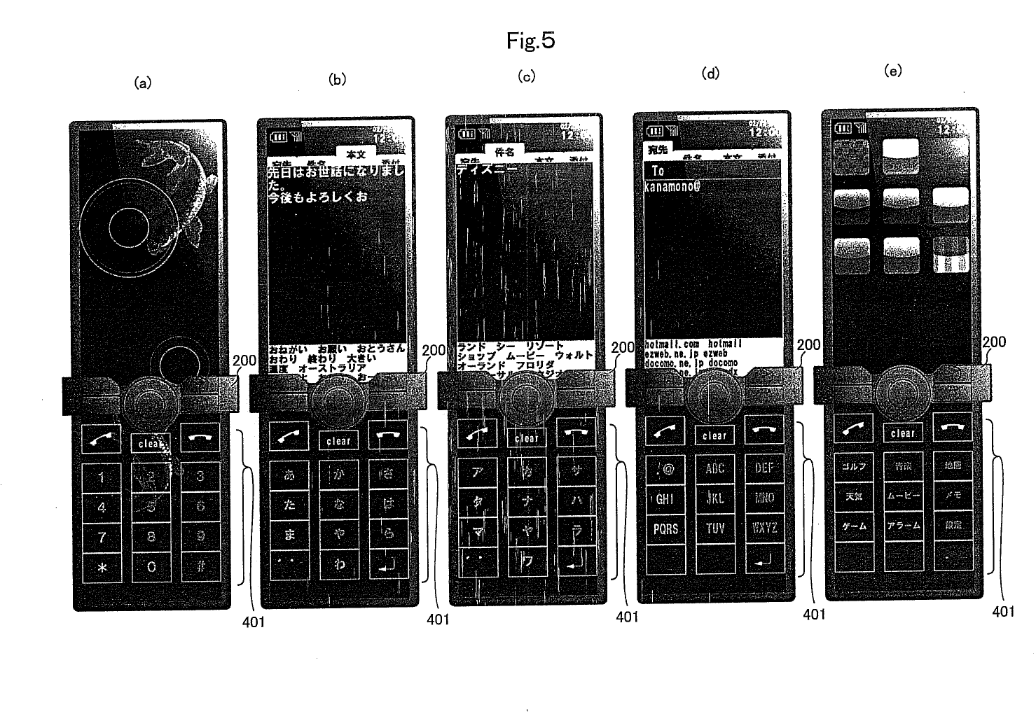

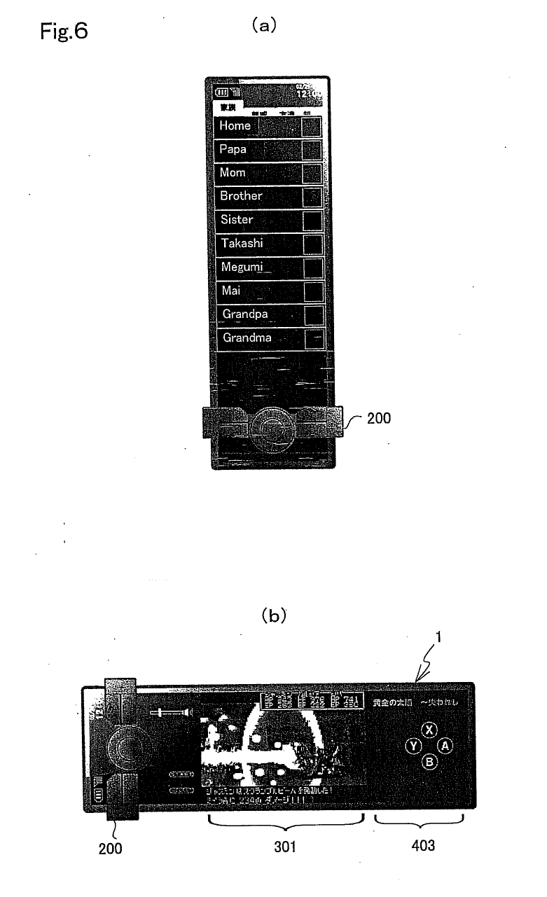

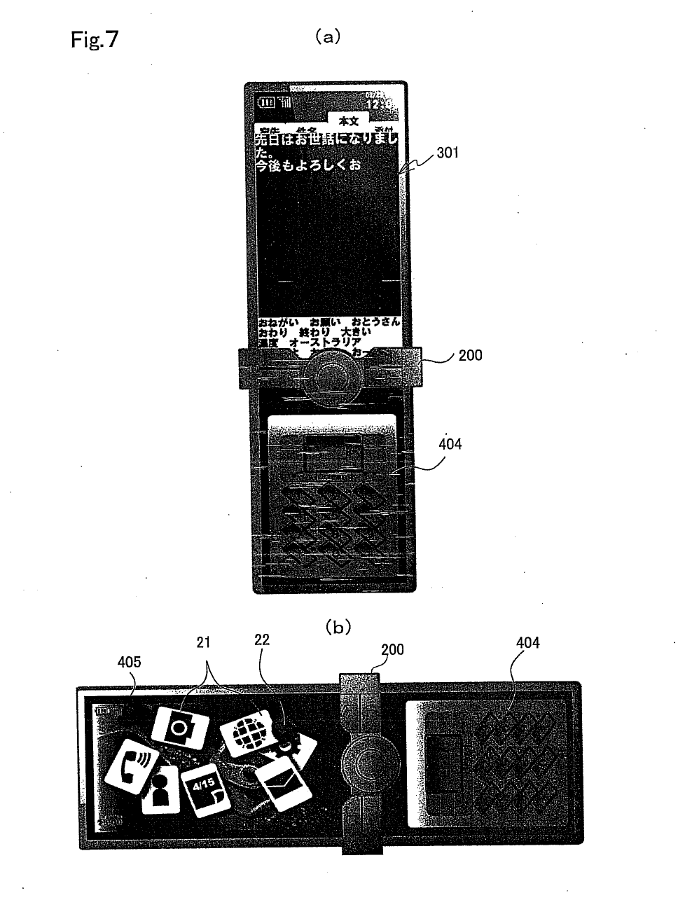

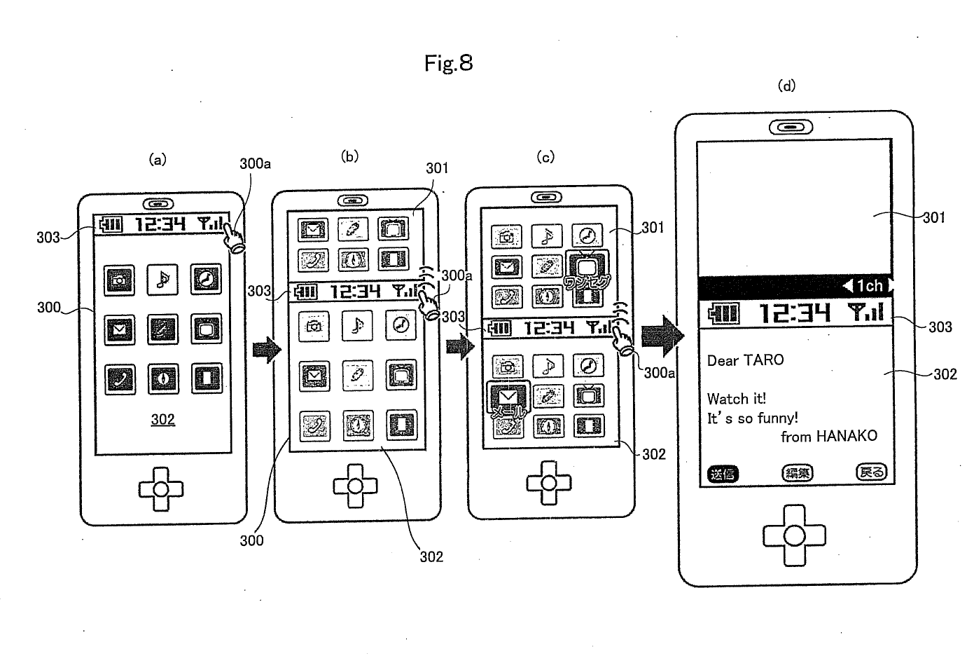

### BRIEF DESCRIPTION OF DRAWINGS

[FIG. 1] An outline view of the portable communication terminal 1 in accordance with an embodiment.

[FIG. 2] A block diagram showing the internal configuration of the portable communication terminal 1 in accordance with the embodiment.

[FIG. 3] A block diagram showing the functional module virtually built on CPU in accordance with the embodiment.

[FIG. 4] An explanatory view showing the case where the display range is divided by making the gadget section into the boundary line in accordance with the embodiment.

[FIG. 5] An character kind inputted depending on the input mode of each application is the explanatory view showing signs that it is changed automatically in accordance with the embodiment. [FIG. 6] An explanatory view about the operation method (game controller mode) of the information terminal in accordance with the embodiment.

[FIG. 7] An explanatory view about the operation method (inclination input key mode) of the information terminal in accordance with the embodiment.

[FIG. 8] An explanatory view about the operation method of the information terminal in accordance with a modification of the embodiment.

### DESCRIPTION OF EMBODIMENTS

With reference to the accompanying drawing, an embodiment of the information terminal related to the present invention is described in detail in the following. FIG. 1 is the outline view of the portable communication terminal 1 in accordance with this embodiment.

As shown in the FIG. (a) and (b), the portable communication terminal 1 is provided with the body 100 of rectangular shape, and the gadget section 200 fit into this body 100, which can be slid to the sliding direction. As for the front side of the body 100, the touch panel 300 was allocated, and the gadget section 200 crossed this touch panel 300, and has fitted in.

As shown in the figure (c), the arrow key 203 operational for all directions is placed in the center by the side of the front of the gadget section 200, and the manual operation button 201, 202 is placed in it by the both sides.

FIG. 2 is the block diagram showing the internal configuration of the portable communication terminal 1 related to this embodiment. As shown in the figure, the portable communication terminal 1 is provided with the duplexer 102 connected to the antenna 101, and the receiving system module and transmission system module which were connected to this duplexer 102.

As the receiving system module, it has the low noise amplifier 110, the mixer 111, IF amplifier 112, the orthogonal mixer 113, A/D converter 114, the demodulator 115, the channel decoder 116, the audio decoder 117, D/A converter 118, the amplifier 119 with the switch and the loudspeaker 120. On the other hand, as a transmission system module, it has the microphone 140, the amplifier 139, A/D converter 138, the voice encoder 137, the channel encoder 136, the modulator 135, D/A converter 134, the orthogonal mixer 133, IF amplifier 132, the mixer 131, and the power amplifier 130.

The portable communication terminal 1 is provided with the synthesizer 103, the time base 150, CPU160, RAM162, ROM163, and EEPROM161 as a control system module, is provided with the acceleration sensor 164, LCD300, the gadget section 200, LED167, the touch sensor 168, and the vibrator 174 as a user interface system module, and is provided with the electrical power system battery 171, the power supply 172, and A/D converter 173 as an electrical power system module.

The antenna 101 transmits and receives the signal to the base station (not shown) via the electric wave line. The duplexer 102 is a circuit which changes input and output of the signal transmitted and received, inputs into the low noise amplifier 110 the signal which the antenna 101 received, and outputs the signal outputted from the power amplifier 130 to the antenna 101.

In the receiving system module, the low noise amplifier 110 amplifies the signal inputted from the duplexer 102, and outputs it to the mixer 111. The mixer 111 undergoes the output of the low noise amplifier 110, separates only specific frequency, and is outputted as an intermediate frequency signal. IF amplifier 112 amplifies the intermediate frequency signal outputted from the mixer 111. The orthogonal mixer 113 undergoes and carries out orthogonal demodulation of the output of IF amplifier 112. The A/D converter 114 digitizes the output of the orthogonal mixer 113. The demodulator 115 restores to the output of A/D converter 114. The channel decoder 116 carries error correction to the output of the demodulator 115. The control message and voice data are contained in the signal which carried error correction. The control message is sent out to CPU160 and voice data is sent out to the audio decoder 117.

The signal inputted into the audio decoder 117 from the channel decoder 116 is decoded by voice data, and is delivered to D/A converter 118. The D/A converter 118 changes the output of the audio decoder 117 into the analog signal. The amplifier 119 with the switch is changed to suitable timing based on the control signal from CPU160, and amplifies the output of D/A converter 118 in the state of the switch ON. The loudspeaker 120 amplifies the output of the amplifier 119 with the switch.

On the other hand, in the transmission system module, the microphone 140 receives the audio signal from the user, and outputs this audio signal as an analog signal. The amplifier 139 amplifies the analog signal outputted from the microphone 140. The A/D converter 138 changes the output of the amplifier 139 into the digital signal. The voice encoder 137 codes and curtails the output of A/D converter 138, and outputs it as voice data. The channel encoder 136 cries the control message from CPU160, and in one voice from the voice encoder 137, and adds the error correcting code.

And the modulator 135 modulates the output of the channel encoder 136. The D/A converter 134 changes the output of the modulator 135 into the analog signal. The orthogonal mixer 133 changes the output of D/A converter 134 into the IF frequency signal (intermediate frequency signal). The IF amplifier 132 amplifies the output of the orthogonal mixer 133. The mixer 131 raises the frequency of the signal which IF amplifier 132 outputs. The power amplifier 130 amplifies the output of the mixer 131.

The synthesizer 103 takes the synchronization of the mixer 111, the orthogonal mixer 113, the mixer 131, and the orthogonal mixer 133 during communication. The time base 150 supplies the clock signal to each part.

In the user interface system, the acceleration sensor 164 is the sensor which detects the value and the direction of acceleration. The LCD165 is a liquid crystal display on which the user is made to display the message, the input character, etc. In GUI on the touch panel 300, the key for inputting the numbers from “0” to “9”, “#”, etc. via this LCD165 can be displayed, and the manipulate signal is acquired through the touch sensor 168 on the touch panel 300.

The gadget section 200 is the input device formed in the longitudinal direction of the surface of the body so that slide movement was available, and equips the front face part with the manual operation button 201,202 and the arrow key (joystick) 203.

The LED167 is for telling the user the message by lighting and putting out lights. The touch sensor 168 detects that the user's finger contacted the touch panel surface, and inputs the manipulate signal with the pressure to the touch panel 300 surface. It may be made for the touch sensor 168 to detect the user's fingerprint. The vibrator 174 is a device which informs mail arrival, and when it receives a message, it will vibrate.

The electrical power system battery 171 supplies electric power to the power supply 172 and A/D converter 173. The power supply 172 is the power supply of the portable communication terminal 1. The A/D converter 173 supplies the signal to CPU160.

The CPU160 is an processing unit which controls each section of the above, carries out sequential execution of the command of the program stored in ROM163, and performs the various functions. The RAM162 is used as a working memory of CPU160, etc. and stores the result of an operation by CPU160 temporarily. The program for CPU160 is recorded on ROM163 and the executive instruction of the program is outputted one by one with the request from the CPU160. The user data, IDs indigenous on the body, and the telephone numbers, such as the abbreviated dialing, are recorded on the EEPROM161.

And as for this embodiment, modules, such as a display information generating section 160a, a manipulation position detector 160c, and an input range setting section 160d, are virtually built by CPU160 by executing the above program by the application execution section 160b as shown in FIG. 3. Here, the “module” in the following explanation is constituted by hardwares, such as the device and apparatus, software with the function, or such combination, and means the functional unit for attaining predetermined operation.

The application execution section 160b is a module for executing the program and builds each above module virtually on the CPU160.

The display information generating section 160a is a module for generating the display information, including the picture, alphabetic information, etc., displayed on the LCD165, and constituting GUI by cooperating with the manipulate signal acquisition section 160f. This display information generating section 160a is provided with the function to divide the display range in the LCD165 into a plurality of display ranges while it sets up the range which displays display information on the LCD165. And the ratio of a plurality of display ranges is changed with the relative position detected by the manipulation position detector 160c.

The display information generating section 160a changes display information according to the coordinate point (the relative position on the touch panel 300) which the manipulate signal was inputted and was detected by the manipulation position detector 160c, and the acceleration detected by the acceleration sensor 164.

The manipulation position detector 160c is a module for detecting the coordinate point specified on the touch panel 300. This coordinate point is detected as a coordinate point of the input position based on the input coordinate of the manipulate signal which the touch sensor 168 detected, and the relative position of the gadget section 200 on the body. The display information generating section 160a changes display information according to the relative position of the gadget section 200 on the body detected by this manipulation position detector 160c.

The input range setting section 160d is a module for dividing the input range of the manipulate signal on the touch panel 300. In the case of the present embodiment, the manipulation position detector 160c detects the operating point on the touch panel 300, and the relative position of the gadget section 200, The input range changes according to this detected relative position and the acceleration which the acceleration sensor 164 detected. The input interface (I/F) 160e is a module which receives the user's manipulate signal inputted from the operation devices, such as the touch panel, the manual operation button, the joystick, and is inputted into the manipulate signal acquisition section 160f.

The manipulate signal acquisition section 160f is a module which inputs the inputted manipulate signal into the application execution section 160b as an operating command. In detail, the manipulate signal is compared with the relative position of the gadget section 200, and the input setting for which the input range setting section 160d determines, the operating command associated with the comparison result and manipulate signal is selected, and is inputted into the application execution section 160b.

### Operation Method

The portable communication terminal 1 which has the above composition is operated as follows. The portable communication terminal 1 is provided with many functions, such as transmission and reception of e-mail, the Internet connectivity, camera photographing, the movie/picture browser, the game, as to the touch panel 300 or the gadget section 200, the manipulate signal and operating command which are assigned to each manual operation button (GUI is included.) are suitably changed according to the input mode in each function.

For example, as shown in FIG. 4, in cases where the touch panel 300 is divided into the above and below display ranges 301 and 302 by making the gadget section 200 into the boundary line, the ratio of the display ranges 301 and 302 changes by sliding the gadget section 200 up and down, and changing the relative position to the body 100. At this time, as shown in the FIG. (b) and (c), the character input key 401 is displayed on the lower display range 302 as GUI as an input range responded the input mode, the display range is expanded and contracted by the slide moving of the gadget section 200.

In addition, in the case of the present embodiment, the auxiliary input key 402 is added and displayed with the character input key 401 by the further upward movement of the gadget section 200. As for this auxiliary input key 402, the character group forecast from the character inputted by the character input key 401 is displayed. In the illustrated example, in cases where Japanese “A” is inputted by the character input key 401, the character group forecast from “A” is displayed. In this way, the above manipulate signal acquisition section 160f changes the coordinates of the input range of each input key according to the expanding and contracting of the input range, and the addition and reduction of the input key, and compares the operating point and the input range of each input key which are inputted by the user's touch operation, and selects the inputted operating command.

As shown in FIG. 5, regarding the input key, the character kind to input is automatically changed according to the input mode of each application. For example, be shown in the figure (a), in the case of calling operation, when alter operation is carried out, the number like the telephone number will be inputted, as shown in the FIG. (b) and (c), in inputting the texts, such as e-mail, it changes to katakana, the hiragana, and Roman letters input, as shown in the figure (d), in the input columns (text box), such as the mail address, the input of the half-width alphabetic characters and the symbols are available. In the figure (e), in cases where it starts application and the function, the menu item is displayed on the input key.

As shown in FIG. 6 (a), in list display modes, such as the address book, it becomes the complete display by lowering the gadget below, at this time, address information can be called by touching the name listed in the list.

As shown in FIG. 6 (b), in cases where the portable communication terminal 1 is used as a game controller, the input range is divided according to the relative position of the gadget section 200 detected by the position detector, and the gadget section 200 and the input range 403 are positioned in the both sides of the display range 301 of display information. Thereby, when the game screen is displayed on the display range 301, the joystick of the gadget as an arrow key and the manual operation button displayed on the input range 403 are placed at the both sides. The position of the gadget section 200 can turn over right and left by slide moving, and the input range 403 can also be positioned in the opposite side of the game screen following it.

As shown in FIG. 7 (a) and (b), at the input range 404, the input key of GUI is placed obliquely the 45 degrees, by detecting tilt of the body with the acceleration sensor, the character to display may be changed corresponding to it. That is, each of the input key displayed cancellous as GUI is tilted the 45 degrees, when the body is stood or lie down, the character is arranged in each readable direction. In cases where it stands, as for these characters, the character in the input key becomes the input character, when it lies, the character besides the input key becomes the input character. In this case, even though the two characters will be assigned to the one input key, the character inputted is switched in the time of lying with the time of standing corresponding to the detection result of the acceleration sensor.

As shown in the figure (b), the left screen 405 is the menu screen of the card game type in the case of the present embodiment. In the menu screen of this card game type, the application and the function for starting are assigned to the card shape icon (card icon) I1 like playing card, and each function can be started by touching this card icon I1. As to this card icon I1, the card icon is shuffled by shaking the body and generating acceleration, the position of the card icon and the overlap can be changed, thereby, the card icon assigned the required function can be moved to the position easy to operate. The box type icon (box icon) I2 is displayed together, and by touching this box icon I2, the card can be aligned or can be put into the box icon I2. By shaking the body, in the screen, this box icon I2 itself can also roll and can be moved.

### Modification Example

Incidentally, the present invention is not limited thereto, but it is possible to add a variety of modification. For example, With the above embodiment, even though modification of the display range and the input range is adjusted by slide moving of the gadget section 200, FIG. 8 (a) be shown in—(d), the coordinate point on the touch panel 300 is appointed by touching and dragging the basic information bar 303 as a boundary line with the finger 300a, the ratio of the display range 301,302 may be changed by making this move up and down.

### Operation/Effect

In accordance with the present embodiment, since the screen is divided into a plurality of display ranges 301, or 302 and the input range 400, the information displayed on the touch panel can be made clear, and the display mode can be varied according to each function of the information terminal, and it is possible to respond to multi-functionalization of the information terminal.

Particularly, in the case of the present embodiment, since the coordinate point on the touch panel 300 can be specified with the position of the gadget section 200 slid to the longitudinal direction of the body 100 surface, by moving the gadget section 200, the boundary line at the time of dividing into a plurality of display ranges can be changed freely, thereby, the area of each display range can be expanded and contracted.

Further, in the case of the present embodiment, since to have further the acceleration sensor 164 for detecting value and the direction of acceleration given to the body 100, the display style can be changed with acceleration given to the body 100 by shaking, tilting, standing or laying in addition to alter operation on the input interface like the gadget section 200 and the touch panel 300.

In addition, as shown in FIG. 7 (a) and (b), the display mode of the display button can be settled without being affected by effect of the direction of the body, since to make the input key of GUI tilt over the 45 degrees, to detect the direction of the body with the acceleration sensor as the input range 404 and to change the character displayed, since the manipulate signal inputted changes responding the direction of the body, the user can carry suitable alter operation by pushing the input key according to the character of the direction easy to read, without being sensible of the direction of the body.

Since the manual operation buttons 201 and 202 and the arrow key 203 are placed as an input part for inputting the manipulate signal into the gadget section 200, the manipulate signal can be inputted also from gadget section 200 itself, and diversification of the interface can be attained. In addition, as shown in FIG. 6, since the input range is divided in order that the gadget section 200 and the manual operation button 403 may be positioned in both sides of the display range 301, the manual operation button and the arrow key can be arranged on both sides of the game screen (display range 301), for example like the game controller.

### REFERENCE SIGNS LIST

1—Portable communication terminal
100—Body
160—CPU
160a—Display information generating section
160b—Application execution section
160c—Manipulation position detector
160d—Input range setting section
160e—Input interface (I/F)
160f—Manipulate signal acquisition section
164—Acceleration sensor
165—LCD
168—Touch sensor
200—Gadget section
201,202—Manual operation button
203—Arrow key
300—Touch panel
300a—Finger
301,302—Display range
303—Basic information bar
400—Input range
401—Character input key
402—Auxiliary input key
403—Manual operation button
404—Input range
405—Left screen

1. An information terminal with a display on the surface of the body comprising:
a display information generating section for generating the display information displayed on the display; and
a position detector for detecting the coordinate point specified on the display;
wherein the display information generating section divides the display into a plurality of the display ranges, and changes the ratio of the a plurality of the display ranges depending on the relative position detected by the position detector.

2. The information terminal as claimed in claim 1 further comprising:
a touch panel provided in the display, for inputting the manipulate signal with the pressure to the display; and
an input range setting section for dividing the input range for the manipulate signal on the touch panel;
wherein the input range setting section changes the input range depending on the relative position detected by the position detector.

3. The information terminal as claimed in claim 1 further comprising:
a gadget section slid to the longitudinal direction in the surface of the body,
wherein the position detector detects the coordinate point with the relative position of the gadget section in the body, and
the display information generating section changes the display information depending on the relative position of the gadget section in the body detected by the position detector.

4. The information terminal as claimed in claim 2 further comprising:
a acceleration sensor for detecting the value and the direction of acceleration,
wherein the display information generating section changes the display information depending on the relative position detected by the position detector and the acceleration detected by the acceleration sensor, and
the input range setting section changes the input range depending on the relative position detected by the position detector and the acceleration detected by the acceleration sensor

5. The information terminal as claimed in claim 3 further comprising:
a input part provided in the gadget section for inputting the manipulate signal.

6. The information terminal as claimed in claim 5 wherein,
the display information generating section has the function for setting up the range which displays the display information on the display, and
the input range setting section each locates the gadget section and the input range in the both sides of the display range of the display information by dividing the input range depending on the relative position detected by the position detector.
